(19) United States
(12) Patent Application Publication
(10) Pub. No.: US 2007/0106592 A1
(43) Pub. Date: May 10, 2007

(54) METHOD AND APPARATUS FOR COLLECTION OF PERSONAL INCOME TAX INFORMATION

(75) Inventor: Francine Messier, Saskatoon, SK (CA)

Correspondence Address: ADAMS EVANS P.A., 301 SOUTH TRYON STREET, SUITE 2180, TWO WACHOVIA CENTER, CHARLOTTE, NC, 28282-1991, US

(73) Assignee: THE TAXTIMER OFFICE SUPPLY CO. INC., Saskatoon (CA)

(21) Appl. No.: 11/460,715

(22) Filed: Jul. 28, 2006

(30) Foreign Application Priority Data
Nov. 10, 2005 (CA) 2526621

(51) Int. Cl. G06Q 40/00

(52) U.S. Cl. 705/36 T

(57) ABSTRACT

An arrangement for organizing information for preparation of an income tax return is provided. The arrangement has a number of tax form sheets with each tax form sheet marked with a relevancy indicator that indicates the type or types of income applicable to the tax form sheet. Each tax form sheet also contains information for aiding a user in gathering data to complete the tax form set, a question requesting data required to prepare the income tax return or a combination of the two. A user can flip through the tax form sheets, only reading or completing the ones that indicate a type of income the user has received. The arrangement can have a case containing a number of tax form sections corresponding to sub-groups of tax form sheets for collecting the tax form sheets after they have been completed by a user.

### TECHNICAL FIELD AND BACKGROUND OF THE INVENTION

This invention is in the field of information collection apparatuses and methods and more particularly apparatuses and methods for collecting personal income tax information.

For income tax reasons, a person has to fill out and submit a personal income tax return to the government each year. This typically involves a person having to collect a wide variety of specific information regarding the person's income in a relevant year and providing this information to the government in the form on a personal income tax return.

It is no secret that completing an income tax return is often quite hard and confusing for those people who do not do it on a regular basis. In order to complete a personal income tax return, a large amount of very specific information is often required and the government forms often require an understanding of common deductions and other technical aspects that a typical person may not be aware of.

Additionally, the government forms often do not provide a person with clear instructions on how to complete the income tax return forms and some sections of the income tax return forms are relevant only to certain types of income. Often, special rules govern the different types of income and these certain types of incomes can be taxed in very different ways. For example, in Canada capital gain income is taxed at a different amount than business income. This different treatment of different types of income often requires income tax return forms to be filled out differently depending on what type of income a taxpayer has.

All of this amounts to a potentially complex situation where completing a tax return can often be confusing to a person, especially if that person has more than one type of income.

Even if the person uses a chartered accountant to complete the necessary income tax return, a lot of information is still required from the taxpayer. The accountant or other professionally may have to repeatedly contact the taxpayer to gather all the necessary information and the taxpayer might find him or herself repeatedly collecting some piece of information for the accountant that is needed to complete the income tax return.

### SUMMARY OF THE INVENTION

It is an object of the present invention to provide a system and method that overcomes problems in the prior art.

The present invention provides a system and method that assists a person in gathering the information necessary to complete an income tax return for submittal to the government.

In a first aspect of the present invention, an arrangement for organizing information for preparation of an income tax return is provided. The arrangement comprises: a tax form set having a plurality of tax form sheets. Each tax from sheet comprises: a relevancy indicator indicating at least one type of income and at least one of: information for aiding a user in gathering data to complete the tax form set; and a question requesting data required to prepare the income tax return, with a corresponding answer space for the user to record the data requested in the question. The at least one of information and a question relates to the at least one type of income identified by the relevancy indicator.

In a further aspect of the present invention, a case having a plurality of tax form sections operative to receive a plurality of tax form sheets is provided. The tax form set is divided into a plurality of sub-groups each sub-group comprising a plurality of tax form sheets and each tax form section of the case corresponds to one of the sub-groups of the tax form set. When a user has completed all of the tax form sheets in one of the sub-groups, the user can insert the tax form sheets in the sub-group in the corresponding tax form section.

In one embodiment the invention comprises a tax form set. The tax form set comprises a number of tax form sheets with each tax form sheet either providing some information to aid a user in gathering the necessary information to later complete an income tax return or one or more questions related to information required to submit an income tax return.

Each of the tax form sheets in the tax form set comprises a relevancy indicator that indicates to the user what types of income are relevant to either the information or the questions on the tax form sheet. In one embodiment, the relevancy indicator is a series of colored check marks, wherein each colored check mark indicates a different type of income, for example, business income could be a green check mark, professional income could be a yellow check mark, commission income could be a purple check mark, rental income could be a blue check mark, daycare income could be an orange checkmark, farming income could be a grey check mark, etc. These specific colors are only provided as a representative example of how the relevancy indicator could work; a person skilled in the art will understand that any color or other indicator that allows a user to quickly differentiate the types of income could be used.

To use the tax form set, a user goes through the tax form set from the first tax form sheet to the last tax form sheet in the tax form set, tax form sheet by tax form sheet. On each tax form sheet the user will look at the relevancy indicator. If the relevancy indicator indicates that the particular tax form sheet is relevant to one of the types of income that the user has received in the relevant year, the user will then read any information on the tax form sheet and/or answer any questions on the tax form sheet. If the relevancy indicator on the tax form sheet does not indicate that it is relevant to any type of income that the user has received in the relevant year, the user will skip over the tax form sheet.

The user will continue to go through the tax form set, tax form sheet by tax form sheet, reading or completing the tax form sheets where the relevancy indicator indicates to the user that a particular tax form is relevant to one or more types of the user's income and skipping over those tax form sheets that do not. When the user has gone through the whole tax form set, the necessary information to complete an income tax return should have been gathered and incorporated into answers in the tax form set.

With the completed tax form set, a user can then complete an income tax return, him or herself, by transcribing the answers on the tax form sheets in the tax form set onto the official governmental income tax returns or alternatively, the user can take the completed tax form set to an accountant or other professional to complete an income tax return for the user. The accountant can then use the information collected by the user in completing the tax form set to fill out an official income tax return for the user. Once the user has completed the tax form set, all of the information necessary to complete an income tax return, should be collected and present in the tax form set, greatly facilitating a user in completing the official income tax return or if the user is using an accountant to complete the income tax return, all of the information the accountant should need to complete an income tax return for the user will be present in the completed tax form set.

In a further embodiment, a transport case is provided. The transport case comprises a number of tax form sections and receipt pockets. A tax form set will be divided into a number of sub-groups. Each sub-group will comprise one or more tax form sheets. Each of the tax form sections in the transport case correspond to one of the sub-groups of the tax form set. When a user has completed the tax forms in a sub-group, the user will place the tax form sheets in the tax form section corresponding to that sub-group and any receipts they have collected in conjunction with that sub-group of tax form sheets will be placed in the receipt pocket. When the tax form set has been completed and all of the tax form set has been placed in the transport case in the correct tax form sections, the user should have the necessary information to complete a personal income tax return well-ordered in the transport case.

By organizing the relevant information and questions to be answered in smaller groupings and indicating the types of income that are relevant to each of the pages, a user can more effectively focus on the necessary questions and information that pertains to him or her because it relates to their type of income. The user can also quickly skip over or ignore information and/or questions that are irrelevant to the user's type or types of income in the relevant time frame. In addition, by organizing the information using the system and method as disclosed, the user or accountant can more easily complete and income tax return in a shorter period of time.

### BRIEF DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a tax form set in accordance with the present invention;

FIG. 2 is a representative tax form sheet providing information to a user, in accordance with the present invention;

FIG. 3 is a further representative tax form sheet providing questions to a user, in accordance with the present invention;

FIG. 4 is a perspective view of a transport case in a closed position in accordance with a further embodiment of the present invention; and

FIG. 5 is a perspective view of the transport case of FIG. 4, in an open position.

### DESCRIPTION OF THE PREFERRED EMBODIMENT AND BEST MODE

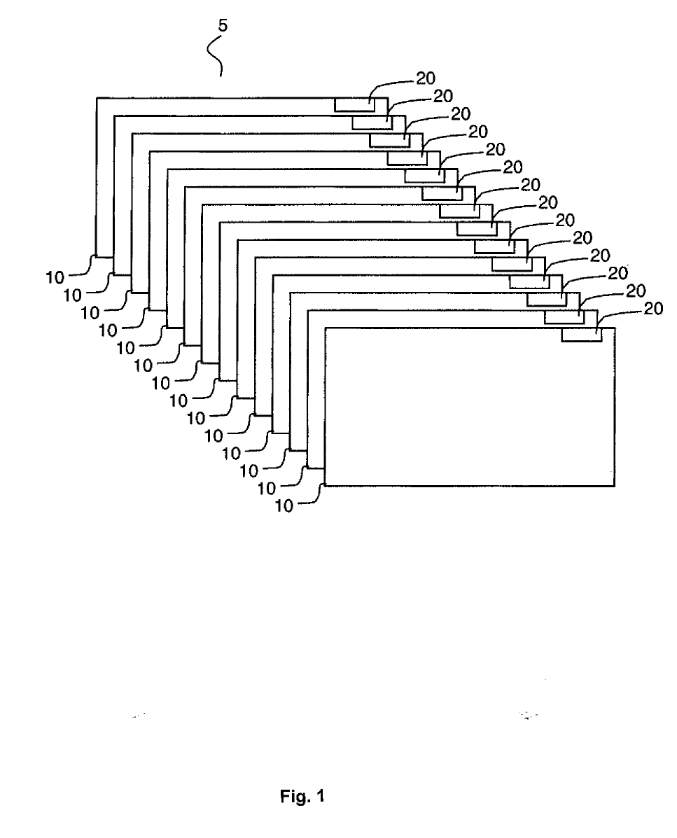

FIG. 1 illustrates a tax form set 5 comprising a plurality of tax form sheets 10, in accordance with the present invention. Tax form set 5 is used to gather all of the information needed to complete a personal income tax return as required on a yearly basis by most governments. The specifics of the tax form set 5 will depend upon the jurisdiction that the tax return is going to be filed in. For example, the layout and some of the information required to complete an income tax return for the United States of America will vary in layout and information required to complete an income tax return for Canada and therefore if the tax form set 5 is to be used to collect information for an income tax return for the United States, the tax form set 5 will be different than if the tax form set 5 will be used for collecting information for an income tax return to be filed in Canada.

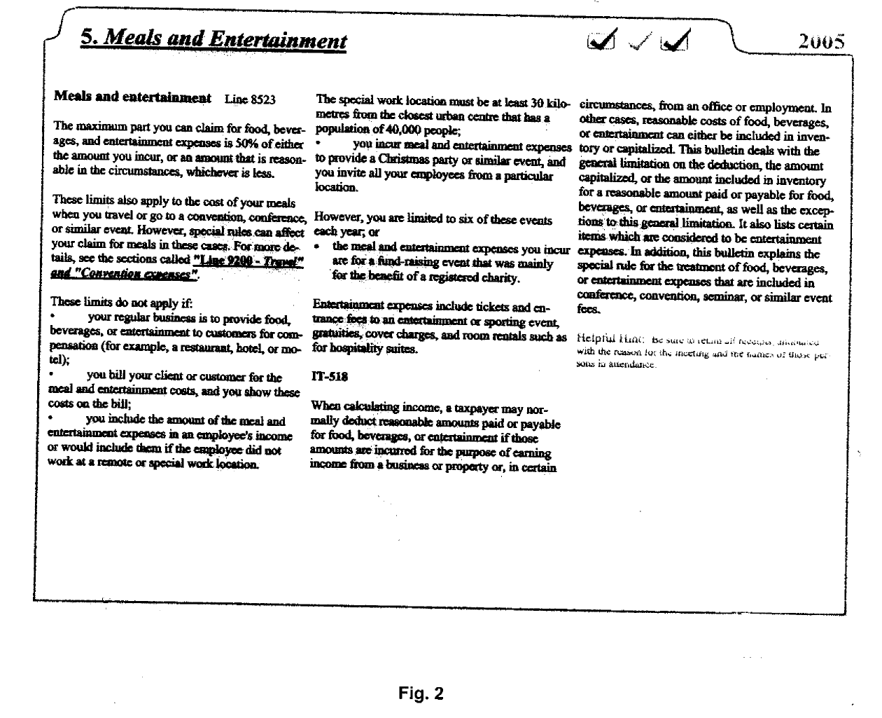

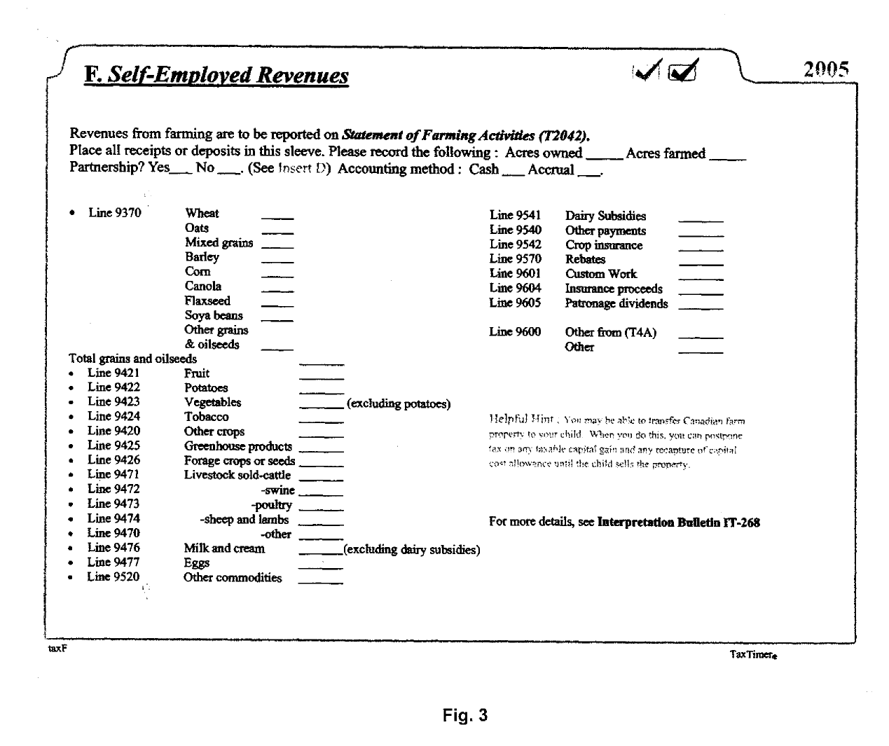

FIG. 2 illustrates a representative tax form sheet 10A that comprises informational content 22. FIG. 3 illustrates a representative tax form sheet 10B that comprises one or more questions 25 and answer spaces 30, each answer space 30 associated with one of the questions 25. Both tax form sheets 10A and 10B comprise a relevancy indicator 20. The relevancy indicator 20 indicates to a user whether the particular tax form sheet 10A or 10B relates to one of the types of income that the user has. For example, business income, professional income, commission income, rental income, daycare income, farming income, fishing income, etc. all require some specialized tax information that is not required for all types of income. In regards to tax form sheet 10A, the information content 22 present on the tax form sheet 10A will be relevant to the types of income indicated in the relevancy indicator 20. In regards to tax form 10B, questions 25 present on the tax form sheet 10B are relevant to the types of income indicated in the relevancy indicator 20.

The relevancy indicator 20 can be any type of indicator that indicates to a user whether the particular tax form sheet 10A or 10B is relevant to the user. However, in one embodiment, the relevancy indicator 20 is a color coded system of checkmarks wherein the user looks to see if the colored checkmarks indicating their income is present. For example, business income could be a green check mark, professional income could be a yellow check mark, commission income could be a purple check mark, rental income could be a blue check mark, daycare income could be an orange checkmark, farming income could be a grey check mark, etc. If a colored checkmark indicating one of a user's types of income is present on the tax form sheet 10A or 10B, the user will then read the tax form sheet 10A or 10B and answer any questions 25 that are on the tax form sheet 10. In this manner, a user can quickly determine whether the tax form sheet 10A or 10B relates to a specific type of income or whether the user must read tax form sheet 10A or answer questions 25 on tax form sheet 10B.

For example, if a user has rental income, a blue checkmark will be shown in the relevancy indicator 20 to indicate that the tax form sheet 10A or 10B is relevant to rental income. If the relevancy indicator 20 on tax form sheet 10A contains a blue check mark, a user will know that the tax form sheet 10A is relevant to rental income and if the user has rental income the user will read the tax form sheet 10A. If a blue check mark is not present and the user only has rental income, the user will ignore tax form sheet 10A.

Referring again to FIG. 1, typically, the relevancy indicator 20 is located in a prominent place on the tax form sheet 10. In this manner, a user flipping through the tax form sheets 10 in the tax form set 5 can easily see and determine whether their types of income are indicated in the relevancy indicator 20.

Referring again to FIG. 2, informational content 22 on tax form sheet 10A relates to information required by a user to complete later questions or gather the necessary information to complete an income tax return. The informational content 22 is relevant to the types of income indicated in the relevancy indicator 20.

Referring to FIG. 3, the questions 25 on tax form sheet 10B correspond to tax information that is required to complete an income tax return for the types of income indicated by the relevancy indicator 20 on the tax form sheet 10B. Each question 25 will ask a question related to the types of income indicated in the relevancy indicator 20. Each question 25 is associated with an answer space 30 for a user to put the answer to the question 25 in.

Some of the questions 25 and their associated answer spaces 30 will have a line indicator 35 that will indicate to the transcriber the correct line on the income tax return to place the information in.

Some tax form sheets 10 may have both information content 22 and questions 25 with corresponding answer spaces 30 all on a single tax form sheet 10.

Referring again to FIG. 1, to use the tax form set 5, a user first determines which type or types of income that he or she has had in the year in question. The user then goes through each of the tax form sheets 10 of the tax form set 5. For each tax form sheet 10, if the relevancy indicator 20 of each tax form sheet 10 indicates to the user that it is relevant to one of that user's types of income the user will then either read the information on the tax form sheet 10 or answer the questions on that tax form sheet 10 by placing his or her answers to the questions in the answer spaces provided for each question. If the relevancy indicator 20 does not include any type of income that the user has had in the relevant time frame, the user will skip over the tax form sheet 10.

The user will continue to go through each of the tax forms 10 in the tax form set 5, tax form sheet 10 by tax form sheet 10, reading the information and answering the questions on each tax form sheet 10 where the relevancy indicator 20 indicates that information or questions on the tax form sheet 10 are applicable to the user's type or types of income and the user will ignore tax forms sheet 10 when the relevancy indicator 20 does not include any type of income that the user has incurred.

When the user has gone through each of the tax forms 10 in the form set 5, and read the information or answered the questions on each of the tax forms 10 where the relevancy indicator 20 indicates they are applicable to the user's type of income, the user will have gathered all of the information necessary to complete an income tax return. The user can then use the completed tax form set 5 to complete an income tax return by transcribing the answers on each of the tax form sheets 10 on to an income tax return form as required by the government.

Alternatively, if the user does not want to complete his or her own income tax return, the user can simply provide the completed tax form set 5 to an accountant and have the accountant complete the necessary income tax return using the information in the tax form set 5. In this manner, the accountant will be provided with all the necessary information resulting in a timely and cost effective tax return on the part of the accountant without requiring the accountant to keep contacting the user requiring further information.

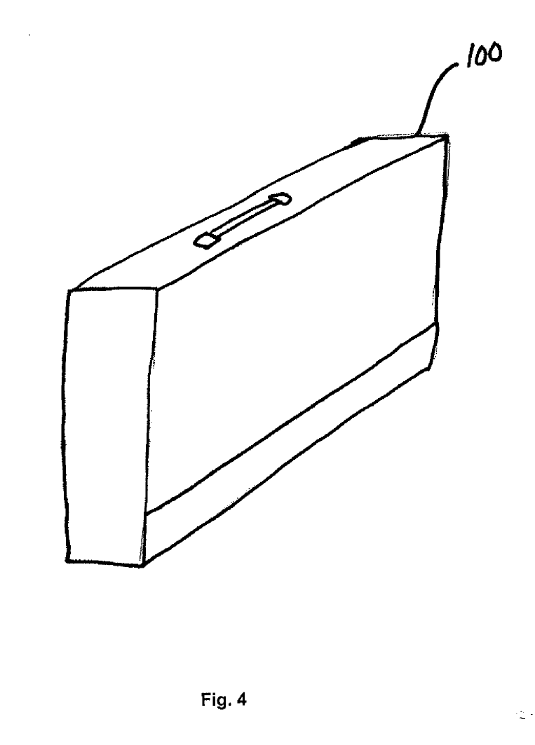

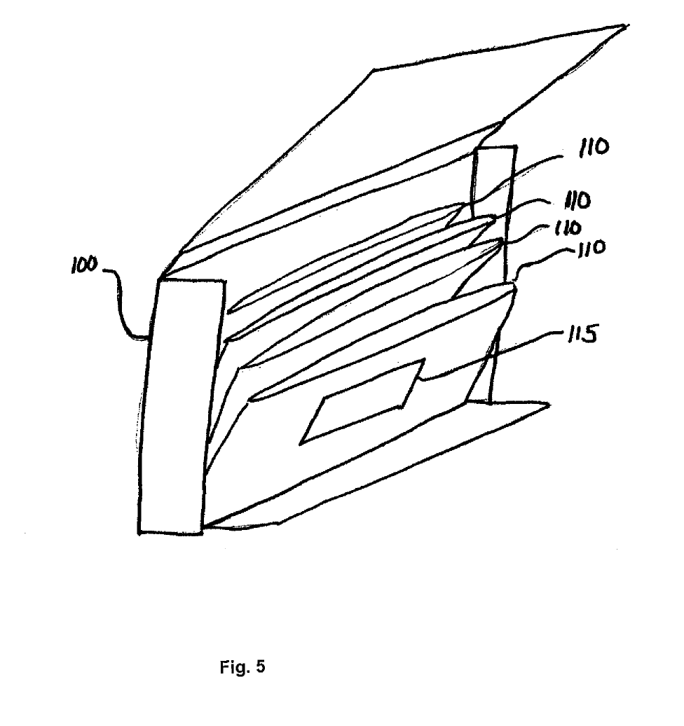

FIG. 4 illustrates a transport case 100 in accordance with a further embodiment of the present invention. FIG. 5 illustrates the transport case 100 in an open position. The Transport case 100 comprises a plurality of tax form sections 110 and a receipt pocket 115 associated with each tax form section 110.

Referring to FIGS. 1, 4 and 5, as the user goes through the tax form sheets 10 in the tax form set 5, the tax forms 10 will be grouped in sub-groups and the each sub-group of the tax form set 5 will have a corresponding tax form section 110 in the transport case 100. As the user completes a sub-group of tax form sheets 10, the user will place that sub-group of tax form sheets 10 in the associated tax form section 110 along with any receipts that are necessary for the sub-group of tax form sheets 10. The receipts will go in the receipt pocket 115 associated with the tax form section 110.

The user can then use the completed tax form set 5 to complete an income tax return. Each tax form section 110 will contain a sub-group of the tax form set 5, which is typically used in a section of the governmental income tax return forms. A user can transcribe information on the tax form sheets 10 in the transport case 110 on to a government income tax form. The user transcribes all of the answers in the answer spaces 30 on each of the tax form sheets 10 in a tax form section 110 and when all the tax form sheets 10 in the tax form section 110 have been transcribed, the user can move on to the tax form sheets 10 in the next tax form section 110.

Alternatively, if the user does not want to complete his or her own income tax return, the user can simply provide the completed tax form set 5 in the transport case 100 to an accountant and have the accountant complete the necessary income tax return using the information in the tax form set 5. The accountant will receive all the tax form sheets 10 ordered in the transport case 100. Additionally, any of the receipts the accountant may need will be contained in the receipt pockets 115. In this manner, the accountant will provided with all the necessary information resulting in a timely and cost effective tax return on the part of the accountant.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

I claim:

1. An arrangement for organizing information for preparation of an income tax return, the arrangement comprising:
a tax form set having a plurality of tax form sheets,
each tax from sheet comprising:
a relevancy indicator indicating at least one type of income and at least one of: information for aiding a user in gathering data to complete the tax form set; and a question requesting data required to prepare the income tax return, with a corresponding answer space for the user to record the data requested in the question,
wherein the at least one of information and a question relates to the at least one type of income identified by the relevancy indicator.

2. The arrangement of claim 1 wherein the relevancy indicator is based on a color and a specific color is assigned to each type of income.

3. The arrangement of claim 2 wherein the relevancy indicator is a colored check mark.

4. The arrangement of claim 1 wherein a question on at least one of the tax form sheets is provided with a line indicator identifying the correct line on the income tax return the at least one of the questions is related too.

5. The arrangement of claim 1 further comprising a case having a plurality of tax form sections operative to receive a plurality of tax form sheets, wherein the tax form set is divided into a plurality of sub-groups each sub-group comprising a plurality of tax form sheets, and wherein each tax form section of the case corresponds to one of the sub-groups of the tax form set, whereby when a user has completed all of the tax form sheets in one of the sub-groups, the user can insert the tax form sheets in the sub-group in the corresponding tax form section.

6. The arrangement of claim 5 wherein each tax form section of the case has a receipt pocket for holding receipts collected in response to a question in a tax form sheet in the sub-group corresponding to the tax form section.

7. A method of organizing information for preparation of an income tax return, the method comprising:
providing a tax form set having a plurality of tax form sheets, each tax from sheet comprising: a relevancy indicator indicating at least one type of income and at least one of: information for aiding a user in gathering data to complete the tax form set; and a question requesting data required to prepare the income tax return, with a corresponding answer space for the user to record the data requested in the question, wherein the at least one of information and a question relates to the at least one type of income identified by the relevancy indicator;
determining at least one type of income a user has incurred in a relevant period;
examining each tax form sheet in the tax form set;
for each tax sheet form having a relevancy indicator identifying the at least one type of income a user has incurred in a relevant period and comprising information, reading the information of the tax form sheet; and
for each tax sheet form having a relevancy indicator identifying the at least one type of income a user has incurred in a relevant period and comprising at least one question, answering the at least one question by entering an answer in the corresponding answer space on the tax form sheet.
